(19) United States
(12) Patent Application Publication
(10) Pub. No.: US 2019/0282417 A1
(43) Pub. Date: Sep. 19, 2019

(54) Mobility Vehicle Enclosure

(71) Applicant: Robert M. Walker, View Park, CA (US)

(72) Inventor: Robert M. Walker, View Park, CA (US)

(21) Appl. No.: 15/920,123

(22) Filed: Mar. 13, 2018

(51) Int. Cl. A61G 3/02; B60P 3/07; B60Q 1/30; B60R 9/06; B60R 11/04; B60R 1/00; B60R 25/20; A61G 3/06

(52) U.S. Cl. CPC A61G 3/0209; B60P 3/07; B60Q 1/305; B60R 9/065; B60R 2011/004; B60R 1/00; B60R 25/20; A61G 3/061; B60R 11/04

(57) ABSTRACT

A mobility vehicle enclosure (MVE) that is secured to a rear location on an automobile, such as a car, truck or van, and encloses a mobility vehicle during storage or transportation. A first design of the MVE has a structure including an upper surface, a lower surface, a front side wall, a rear side wall and a left side wall. The structure is preferably rectangular shaped, although any shape can be used depending on the requirements of the application. The front side wall is secured to the structure by an upper securing device and at least one hinge that is attached at a lower edge of the front wall and a front edge of the lower surface. The hinge allows the front side wall to be lowered downward to ground level, thereby creating a ramp on which a mobility vehicle enters or exits the structure. A second design of the MVE is similar to the first, except the surfaces and side walls of the structure are all secured together by hinges. By using the hinges, the surfaces and side walls can be folded on top of each other, thereby creating a vertical stack that can be stored in a small space when the MVE is not in use. To assemble the second design, the surfaces and side walls are unfolded, and the final side wall is secured to the initial side wall. The number of side walls used is determined by the required shape of the structure. Both designs also have a MVE to automobile securing apparatus, which is based on a conventional trailer hitch, and a rear light assembly which provides rear light on the MVE when the MVE is in place blocking the automobile's rear lights.

### TECHNICAL FIELD

The invention generally pertains to mobility vehicles, and more particularly to an enclosure that is secured to the rear of a car, truck, van or other automobile for storage and transportation of a mobility vehicle.

### BACKGROUND ART

One of the most difficult disabilities for a person to have to live with is the inability to walk. Not being able to walk, and to move about independently, can significantly limit a person's ability to participate in life. As a result, a long time ago, a solution to this was required. There have been many devices and products developed to assist a person with walking. Arguably, the most successful has been the wheelchair.

The relatively simple wheelchair provided a non, or limited, walking person the ability to independently move from place to place. The original type non-powered wheelchair design is still basically used. There have also been powered wheelchairs. The latest development stemming from the powered wheelchair is known as a mobility vehicle or scooter. These mobility vehicles are available in a variety of styles including two-wheel scooters, three-wheel scooters, etc. The scooters are preferred over wheelchairs because the scooter design provides a vehicle that is more maneuverability, easier to store and transport, and typically easier to access and use even by a single disabled person.

In order to use a mobility vehicle in their daily life, a person must be able to transport the mobility vehicle to different locations. For people wo do not own vans or trucks, the most common method of accomplishing this is the use of a specialty made bracket apparatus that is attached to the rear of an automobile. The bracket extends outward and a mobility vehicle is secured onto the bracket during transportation. The bracket does provide a method of transporting a mobility vehicle, but there are significant drawbacks. It can be difficult, especially for a single person, to life a mobility vehicle up and onto the bracket. Also, in most cases, a mobility vehicle on a bracket is completely exposed. This could result in damage that occurs during transportation.

The solution to these problems would be to provide a means by which a mobility vehicle could be stored and/or transported, either when secured to the rear of an automobile or when not secured. Optimally, an enclosure into which a mobility vehicle could be quickly and easily placed into or removed from. An enclosure such as this would provide complete protection against damage, and would also allow a mobility vehicle to be kept on an automobile without fear of theft or vandalism.

A search of the prior art did not disclose any literature or patents that read directly on the claims of the instant invention. However, the following U.S. patents are considered related:

| U.S. PATENT NO. | INVENTOR | ISSUED |
|---|---|---|
| 4,705,448 | Mungons | Nov. 10, 1987 |
| 5,011,361 | Peterson | Apr. 30, 1991 |
| 8,287,023 | Bixler, etal | Oct. 16, 2012 |

The U.S. Pat. No. 4,705,448 patent discloses a carrier apparatus that is adapted for external attachment to a motor vehicle for carrying a three-wheeled vehicle externally to the motor vehicle. The carrier apparatus has three major subcomponents: a main support member, which is rigidly affixed to a portion of the vehicle, a multidimensional tilting device and a separate carrying platform. The main support member pivots the carrier from a horizontal position upward to a position vertically aligned along the vehicle. A further pivoting device is provided to tilt the carrier downwardly to the ground in order to receive the three-wheeled vehicle from the ground, or reciprocally to unload the three-wheeled vehicle from the carrier.

The U.S. Pat. No. 5,011,361 patent discloses a carrier for scooters used by disabled persons. The carrier is attachable to a motor vehicle and has a mast with a power lift which moves a foldable platform between lowered raised positions. A pedal on the platform responds to the presence of a load and defeats the platform fold-up mechanism. In the absence of a load, the platform will assume a folded position against the mast when raised. A fold-down lever with an attached foot pivots to engage the scooter when the platform is raised in a horizontal position with a load thereon.

The U.S. Pat. No. 8,287,023 patent discloses an enhanced mobility device enclosure defining an interior and an exterior and having a floor defining an opening therein. At least one access opening allows passage between the exterior and interior. The access allows passage of a personal mobility device from the exterior to the interior where the mobility device may be secured to the enclosure by clamps.

For background purposes and indicative of the art to which the invention relates, reference may be made to the following remaining patents found in the patent search.

| U.S. PATENT NO. | INVENTOR | ISSUED |
|---|---|---|
| 4,270,791 | Tann | Jun. 2, 1981 |
| 5,122,024 | Stokes | Jun. 16, 1992 |
| 5,137,411 | Eul, et al | Aug. 11, 1992 |
| 6,279,986 | Hinsperger | Aug. 28, 2001 |
| 6,659,211 | Esposito | Dec. 9, 2003 |
| 9,688,336 | Lafleur | Junl. 27, 2017 |

### DISCLOSURE OF THE INVENTION

A mobility vehicle enclosure (MVE) that is secured to a rear location on an automobile, such as a car, truck or van, and encloses a mobility vehicle during storage or transportation. The MVE has a structure including an upper surface, a lower surface, a front side wall, a rear side wall, a right side wall, and a left side wall. The structure surfaces and walls can be made of a various materials such as plastic, metal, wood, or a composite, and the complete structure can be made of a single material or multiple materials can be used, with certain materials selected from particular applications.

Attachment means are utilized for securing together the upper surface, the lower surface, the rear side wall, the fright side wall and the left side wall. The use of the above surfaces and side walls creates a substantially rectangular shaped structure, which is preferred, although other shapes can be created and will function with equal efficacy. The attachment means can consist of screws, bolts and nuts, an adhesive, welding or a clamp. Also, the MVE structure can be made of plastic form a mold. The front side wall is secured to the structure by an upper securing device and at least one hinge that is attached at a lower edge of the front side wall and a front edge of the lower surface. When the upper securing device is released, the hinge(s) allow the front side wall to be lowered angularly downward to ground level, thereby creating a ramp on which a mobility vehicle enters or exits the structure.

Extending outward from the lower edge of the right side wall is a MVE to automobile securing apparatus, which facilitates the temporary securement of the MVE to the rear of an automobile. Attached onto the lower edge of the left side wall is a rear light assembly. When the MVE is secured to the rear of an automobile, often the automobile rear lights are obstructed by the MVE structures. The rear light assembly that is attached to the MVE provides a standard light, a brake light and a reverse light, all of which are actuated by the automobile's existing light circuitry and are viewable from behind the MVE when the MVE is secured to an automobile.

Located within the structure, resting on the lower surface, is a grated panel which provides a secure surface on which a mobility vehicle is placed when inside the structure. The grated panel also allows straps to be threaded through the grates and secured to the mobility vehicle.

In an alternate design, the structures surfaces and side walls are all attached together by hinges. This hinge attachment allows the surfaces and side walls to be folded one onto another at the edges. The folded structure compound can be stored/maintained in a horizontal, flat orientation until the MVE is to be used. To assemble the structure the surfaces and side walls are simply un-folded into a geometric shape as determine by the number of side walls. For example, the preferred rectangular structure would require four side walls, a single rear wall and a single front wall which functions as an enter/exit ramp as previously disclosed. Once unfolded the final side wall is secured to the initial side wall, thereby creating the structure.

In view of the above disclosure, the primary object of the invention is to provide a mobility vehicle enclosure that can secure a mobility vehicle within a safe and clean structure during storage and transportation of the vehicle.

In addition to the primary object, it is also an object of the invention to provide a mobility vehicle enclosure that:
is easy to use,
can be quickly and easily secured at the rear of an automobile,
can be secured to a variety of automobiles including cars, trucks, vans or other vehicles,
can be made in a variety of shapes and sizes, and from a variety of materials,
is robust and long-lasting
is easy to clean and essentially maintenance free,
can be sold as an aftermarket accessory or as an OEM product along with an automobile,
reduces potential damage to a mobility vehicle during transportation by completely enclosing the vehicle,
protects a mobility vehicle against theft and vandalism, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic front view of a first design of a mobility vehicle enclosure (MVE) with a front side wall in a downward position functioning as a ramp.

FIG. 2 is an orthographic front view of the MVE secured to the rear of an automobile with a mobility vehicle positioned to be rolled up the ramp into the MVE structure.

FIG. 3 is an orthographic rear view of the MVE placed on a support assembly with the front side wall in the downward ramp position.

FIG. 4 is an elevational side view of the MVE placed on the support assembly.

FIG. 5 is an elevational front view of the MVE.

FIG. 6 is an elevational rear view of the MVE placed on the support assembly.

FIG. 7 is a top plan view of the MVE placed on the support assembly with the front side wall in the downward ramp position.

FIG. 8 is an orthographic view of the MVE with the front side panel in an upward, almost closed position.

FIG. 9 is an orthographic view of a second design of the MVE with hinged walls and surfaces that fold from a flat position into the structure.

FIG. 10 is an orthographic view of the second design of the MVE the hinged walls and surfaces as they are folded into the structure.

### BEST MODE FOR CARRYING OUT THE INVENTION

The best mode for carrying out the invention is presented in terms that disclose a preferred embodiment with multiple designs of a mobility vehicle enclosure (MVE). For many people it is difficult or impossible to walk, so to provide assistance or the ability to move around independently, devices have been developed. The most common device is a wheelchair, which has been in use for a long duration. As time progressed and technology improved, so did the designs and functionality of a wheelchair, which are available in both powered or non-powered configurations During more recent times, the wheelchair has led to the development of what is commonly referred to as a mobility vehicle or a handicap scooter. There are many variations of mobility vehicle designs, but all designs provide improved functionality over a wheelchair, such as significantly improved maneuverability.

A problem does exist in that even though a mobility vehicle is an effective means of providing independent movement, a mobility vehicle must be transported to a location(s) where it will be used. The most widely utilized method of accomplishing this is an apparatus that is attached to a rear of an automobile, such as a car, truck or van. A major drawback is that during transportation the mobility vehicle is usually totally exposed. The MVE 10 offers a solution to this problem by providing an enclosure that is attached to the rear of an automobile and completely and securely houses a mobility vehicle during transportation or storage.

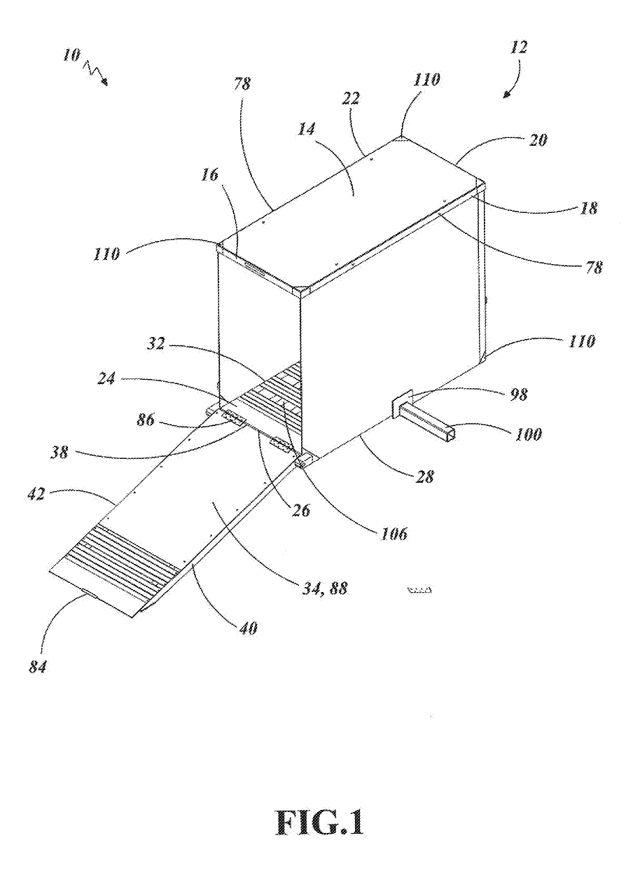

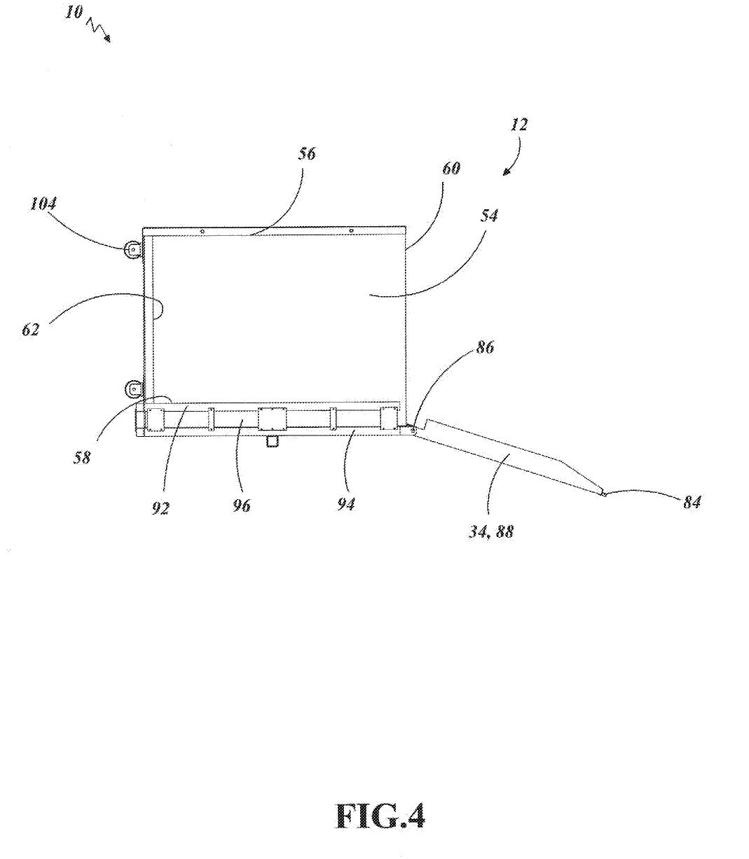

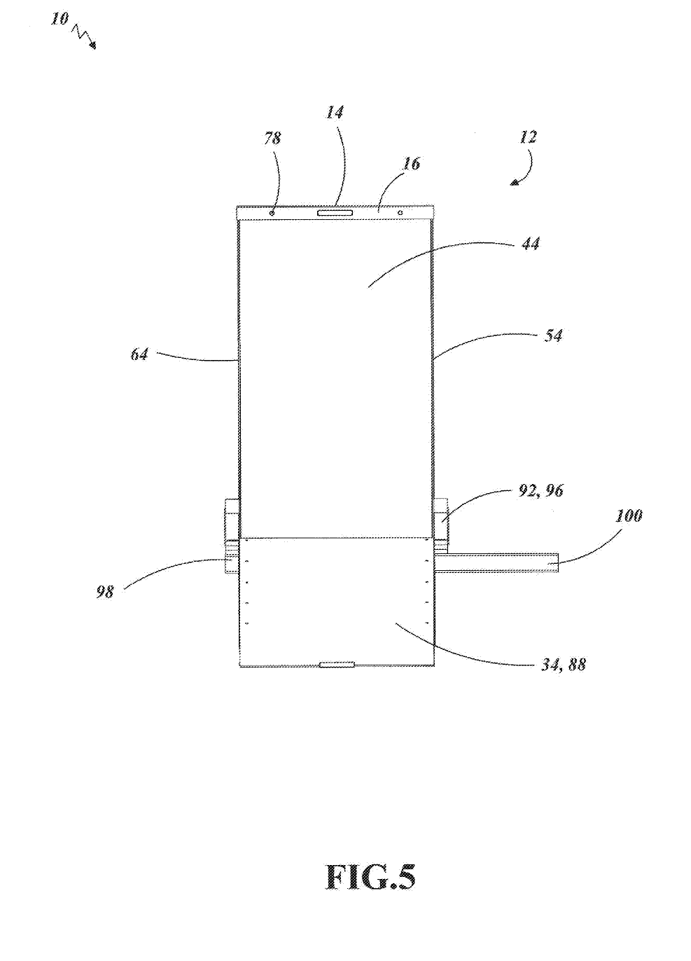

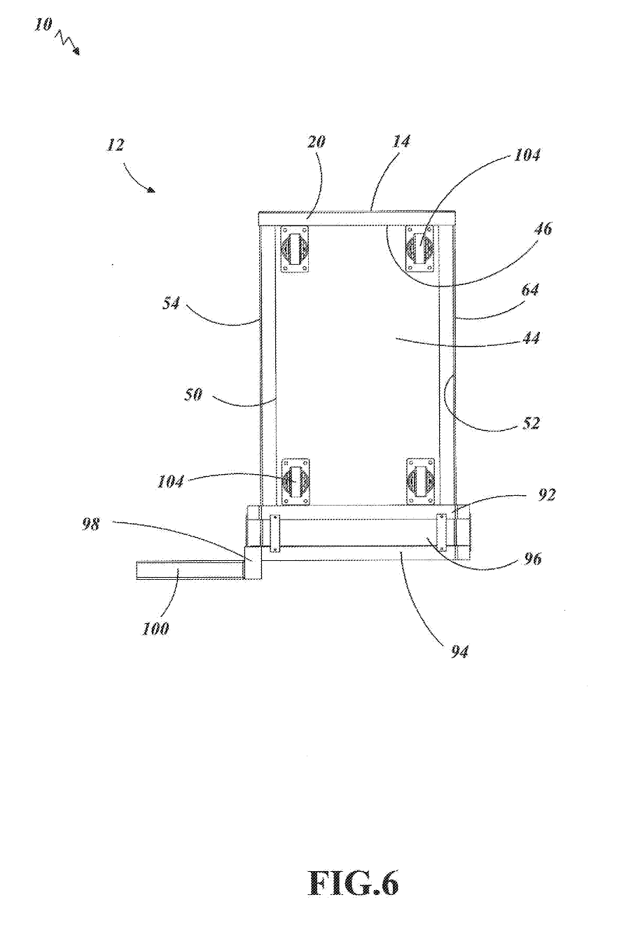

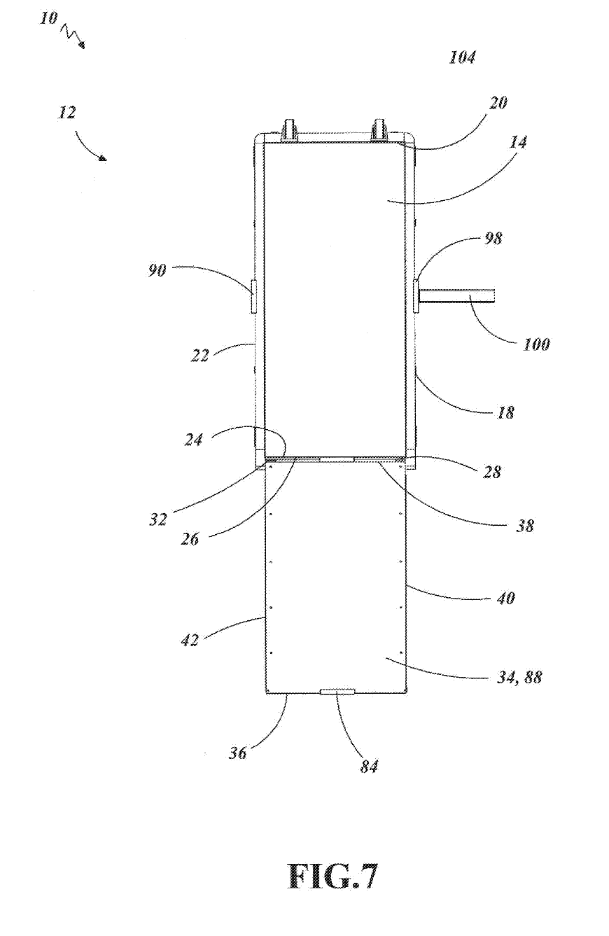

The MVE 10, as shown in FIGS. 1-10, has two main embodiment designs. The first embodiment design, as shown in FIGS. 1-7, is comprised of the following major elements: a structure 12, a rear light assembly 90, and a securing apparatus 98.

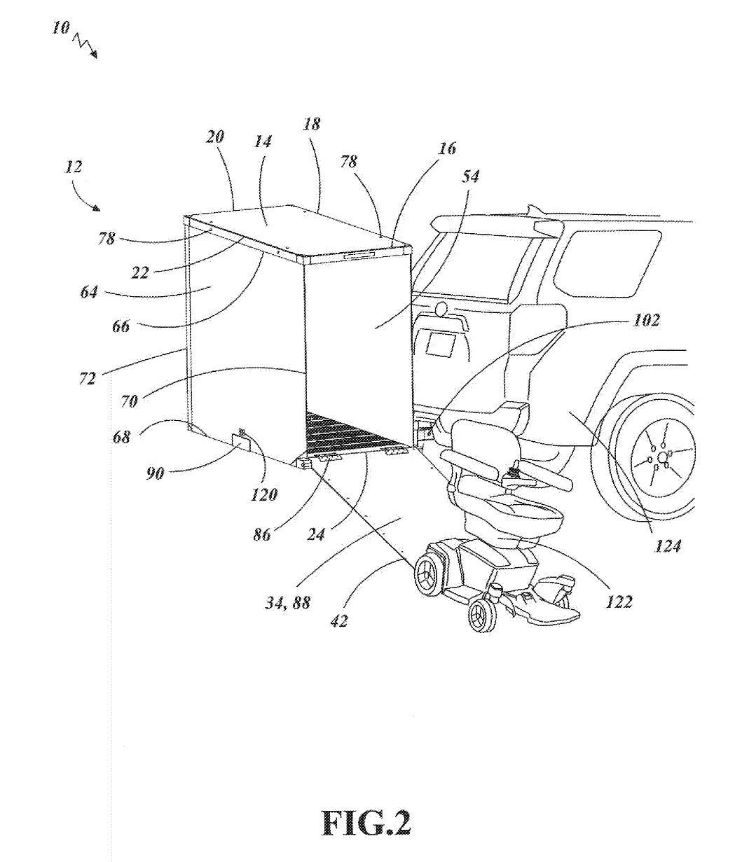

It should be noted that the MVE 10 is disclosed and shown from a perspective of the front of the MVE 10 being where a mobility vehicle enters or exits which is perpendicular to an automobile. The MVE 10 is designed to be secured to and used in combination with an automobile 124, which for the purpose of this disclosure includes a car, a truck, a van, an all terrain vehicle (ATV) or any other similar vehicle, as shown in FIG. 2. Although, the use of the MVE with an automobile is the primary function, the MVE 10 can also be used apart from an automobile to effectively store a mobility vehicle.

The structure 12 includes an upper surface 14 with a front edge 16, a right edge 18, a rear edge 20, and a left edge 22; a lower surface 24 with a front edge 26, a right edge 28, a rear edge 30, and a left edge 32; a front side wall 34 with an upper edge 36, a lower edge 38, a right edge 40, and a left edge 42; a rear side wall 44 with an upper edge 46, a lower edge 48, a right edge 50, and a left edge 52; a right side wall 54 with an upper edge 56, a lower edge 58, a front edge 60 and a rear edge 62; and a left side wall 64 with an upper edge 66, a lower edge 68, a front edge 70 and a rear edge 72. All of the surfaces and walls of the structure can be made of a variety of materials including metal, plastic, wood or a composite. Also combinations of two or more different materials can also be used.

In this first design, attachment means 78 are utilized to secure together the upper surface 14, the lower surface 24, the rear side wall 44, the right side wall 54 and the left side wall 64. The attachment means 78 can be permanent or non-permanent and include screws, bolts and nuts, an adhesive, welding or clamps. The preferred final shape of the MVE 10 is rectangular, as shown in FIGS. 1-8, which is particularly effective for enclosing many types of mobility vehicles. Although a rectangular shape is preferred, the MVE structure can be any geometric or non-geometric shape depending on the use and requirement(s).

Located at and interfacing with the upper edge 36 of the front side wall 34, and the front edge 16 of the upper surface 14 is an upper securing device 84, as shown in FIGS. 1, 3, 7 and 8. The upper securing device 84 secures the front side wall to the upper surface and allows the front side wall 34 to be maintained in an upward closed position. As shown in FIGS. 1, 2, 4, and 8, attached at the lower edge 38 of the front side wall 34 and the front edge 26 of the lower surface 24 is at least one hinge 86. When the upper securing device 84 is released, the hinge 86 allows the front side wall 34 to be lowered angularly downward with the upper edge 36 of the front side wall 34 resting at ground level, thereby creating a ramp 88 on which a mobility vehicle 122 enters or exits the structure 12, as shown in FIG. 2. Also, to provide a smooth transition onto the ramp from the ground, a ramp extension, with or without a textured surface, can extend from the lower edge of the ramp, as shown in FIG. 1. The extension provides easier access to the ramp when a mobility vehicle is entering or exiting the structure.

As shown in FIGS. 2, 7 and 8, a rear light assembly 90 is attached to the substantial midpoint on the lower edge 68 of the left side wall 64. The rear light assembly 90 interfaces with the automobile's existing rear light circuitry. When the MVE 10 is secured to a rear location on an automobile, the automobile's rear lights are blocked. The MVE rear light assembly provides a standard light, a brake light, and a reverse light that are actuated by the automobile's light circuitry and are viewable from behind the MVE when the MVE is secured to an automobile.

In order to secure the MVE 10 to the rear of an automobile a MVE to automobile securing apparatus 98 is utilized. The securing apparatus 98, as shown in FIGS. 1-7, is a commonly known as a trailer hitch and is used as a means of securing items such as trailers to other vehicles. The apparatus 98 is comprised of a male member 100 that extends outward from the lower edge of the right side wall and is inserted within a female member 102 located at a lower rear area of the automobile. Once the male member 100 is within the female member 102, a locking pin is inserted through openings on both members, thereby maintaining the MVE in an upright level position at the rear of the automobile and securing the MVE to the automobile. Also a conventional ball type trailer hitch can be effectively utilized.

Located within the structure 12 and laying upon the lower surface 24 is a grated panel 106, as shown in FIGS. 1-2, the granted panel 106 provides a secure surface on which a mobility vehicle 122 rests upon when the mobility vehicle is within the MVE. Also, straps 108 can be inserted through the grates and secured to the mobility vehicle.

The final component of the first design of the MVE 10 are corner guards 110. As shown in FIG. 1, a single corner guard 110 is placed at each corner where the upper and lower surfaces interface with the side walls. The corner guards strengthen the structural integrity of the structure and protect the corners from damage.

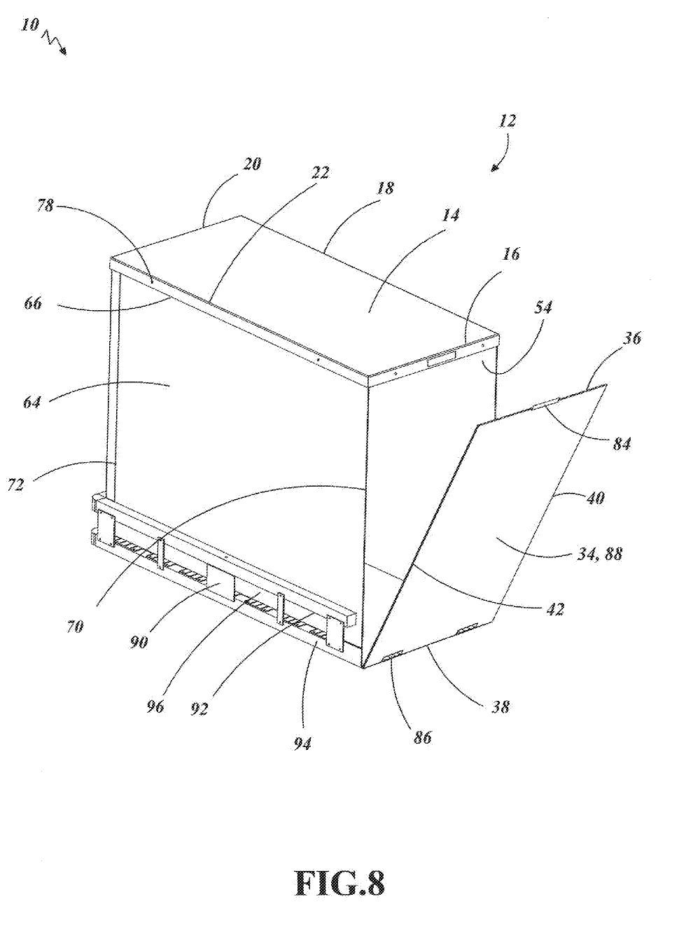

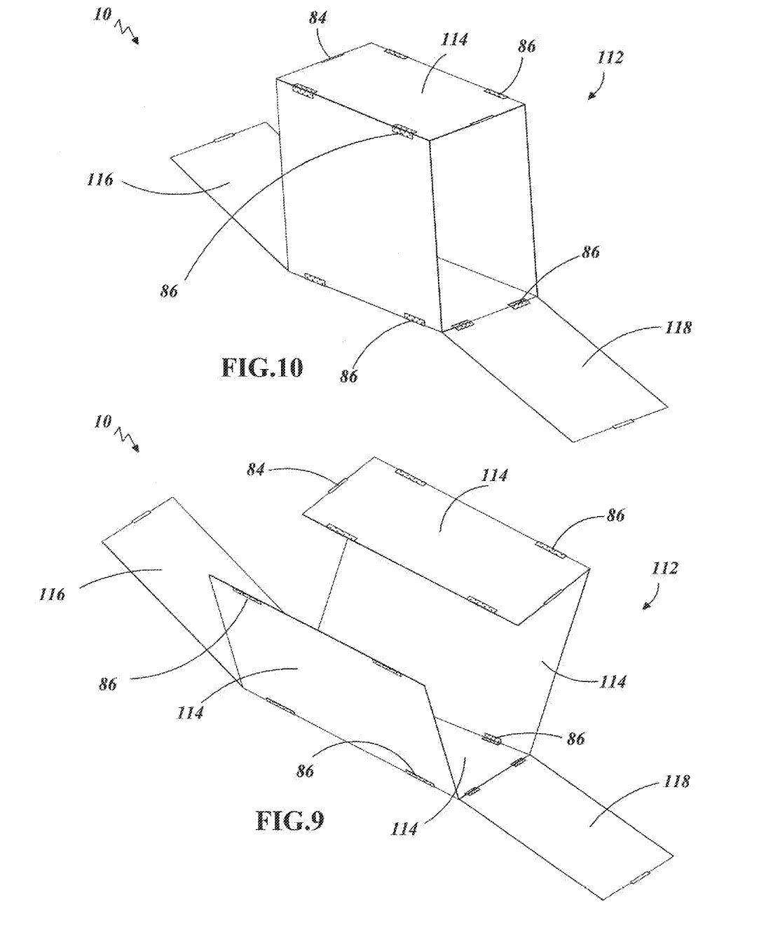

The second embodiment design of the MVE 10 is similar to the first design, except the surfaces and side walls are secured together by hinges (or other means such as resilient bands that allow the surfaces and walls to flex and pivot about each other). In the second design, as shown in FIGS. 8-9, the MVE 10 is also comprised of a structure 12 including multiple surfaces and side walls, and a rear side wall and a front side wall. The number of surfaces and side walls can vary, depending on the shape of the MVE 10. As with the first design, the structure preferably has a rectangular shape requiring an upper surface 14, a lower surface 24, a front side wall 34, a rear side wall 44, a right side wall 54 and a left side wall 64. Other shapes, such as a pentagon or octagon are also viable but require additional surfaces and side walls. Also, the front and rear side walls must be shaped to conform to the structure shape. For the purpose of this disclosure, the rectangular shape structure will be disclosed and shown for the second design.

To differentiate the second design from the first design, the structure is identified as number 112 in FIGS. 8-9. The upper and lower surfaces, and two side walls are identified as perimeter side walls 114 since, as previously disclosed, there could be multiple required depending on the structure shape. The front and rear side walls are identified as 116 and 118.

As shown in FIGS. 9 and 10, each perimeter side wall 114 has an upper edge a lower edge, a right edge and left edge, a rear side wall with an upper edge, a lower edge, a right edge, and a left edge, and at least four perimeter side walls, with each perimeter side wall having an upper edge, a lower edge, a front edge, and a rear edge. The perimeter side walls are secured together by at least one hinge located at each interfacing upper and lower edge, and the front and rear side walls are secured by at least one hinge at the front or rear edge of the perimeter side wall in an upper or lower location. The hinge securement allows the structure to be maintained in a horizontal orientation, with the perimeter side walls folded and stacked upon each other, and the front and rear side walls to be folded at front and rear locations on the stacked perimeter side walls. To assemble the structure, the perimeter side walls are sequentially unfolded and positioned into a geometric shape. A final perimeter side wall is releasably secured to an initial perimeter side wall by non-permanent attachment means comprising screws, snap-in, detents, bolts and nuts, or clamps. Once assembled, the structure is secured to a rear location on an automobile by a MVE to automobile securement apparatus. A rear light assembly is placed at a rear location on the structure, wherein the rear light assembly interfaces via a cable with an automobile's existing rear light circuit to provide a standard light, a brake light, and a reverse light that are actuated by the automobile's light circuitry and are viewable from behind the MVE 10 when the MVE is secured to the automobile 124. When the structure is assembled, the front side wall is maintained in an upward closed position by a securing device located at an upper edge of the front wall and front edge of an upper positioned perimeter side wall. When the securing device is released, the front side wall pivots on the at least one hinge located at the lower edge to a downward angled position reaching ground level. In the downward position the front side wall functions as a ramp that allows a mobility vehicle to enter or exit the MVE 10.

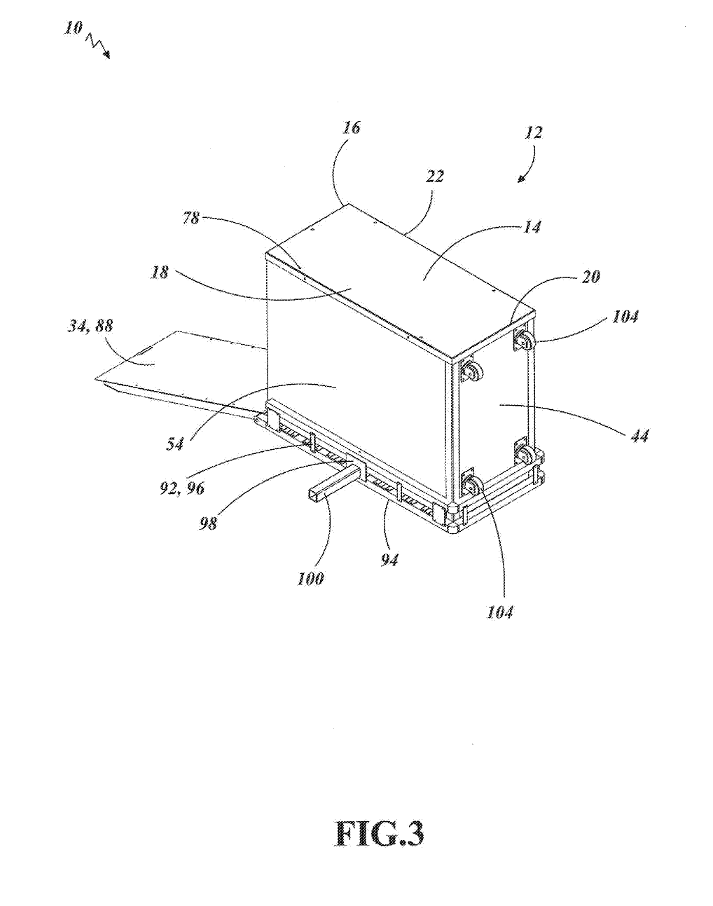

As shown in FIGS. 3-7, a support assembly 92 can be used with either design of the MVE 10. The support assembly 92 is comprised of a base 94 and a perimeter rail 96 that extends around and upward from side edges of the base 94. The support assembly also has a rear light assembly 90, as shown in FIGS. 2, 7 and 8, that interfaces with an automobile's existing light circuitry and is attached to a substantial midpoint at a rear-facing location on the support assembly, and a MVE to automobile securing apparatus 98 that includes a male member extending outward form a substantial midpoint at a front-facing location on the support assembly. Both the rear light assembly 90 and MVE to automobile securing apparatus 98 are the same in structure and function to the similar components utilized directly on the MVE structure 12. The support assembly 92 is dimensioned to allow the MVE structure 12 to be placed on the base 94 within the confines of the perimeter rail 96, as shown in FIGS. 3, 4, 6 and 8. The support assembly with the structure thereon is then secured to a rear location on an automobile. Once secured, the structure's first side wall can be lowered to a downward position, where the side wall functions as a ramp to allow a mobility vehicle to enter or exit the structure.

To add further utility to both designs, a power source that functions to charge a mobility vehicle's battery can be placed within the structure 12. The power source is also rechargeable and a power cable is used to connect the power source to a utility power outlet for charging. The power source could also supply power to at least one interior light located within the enclosure. The interior light could also be powered from the automobile's light circuitry which powers the rear light assembly 90.

Also, as shown in FIGS. 3, 4, 6 and 7, wheels 82 can be attached to the outer surface of the third side wall. The wheels can be any type including casters or preferably swivel casters, and when the structure is rectangular shaped, the wheels are attached at each of the four corner locations. The wheels allow the structure to be rolled form one location to another. For example, when the MVE is not in use, the MVE can be stored in a convenient location such as a garage. Then when the MVE is required, the structure can be quickly and easily rolled to a location where an automobile to which the MVE will be secured is located.

In order to provide security to either design, a clasp 104 can be attached to the front side wall and the upper surface. A conventional padlock can then be affixed to the clasp to lock the front side wall in the upward closed position. Additionally, if desired, a cable, preferably make of metal can be placed around the structure. The cable which can be used with or without a padlock can also be placed around the structure and secured onto the automobile, thereby locking/securing the entire MVE to the automobile 120. Additionally, a rear-view camera 120, as shown in FIG. 2, can be secured at a location on the left side wall, thereby directing the view of the camera to an area behind said MVE and the automobile, wherein the rear-view camera 120 is a self-contained apparatus that functions in combination with a screen that is mounted within the automobile in a viewable position by a driver of the automobile, wherein the rear-view camera 120 allows the driver of the automobile to view an area that is blocked by the MVE behind the automobile.

In another alternate design the structure 12 can be circular shaped, similar to a tube. One benefit to this design is that the structure can be made of two pieces: a main body and a front side wall which also functions as a ramp. A circular structure could be made of plastic and molded with the main body has a single piece. This would create a structure that could be watertight and (with additional sealing) airtight. As with the other designs, the circular structure would also utilize the MVE to automobile securing apparatus 98 and a rear light assembly 90 as previously disclosed.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A mobility vehicle enclosure (MVE) that is secured to a rear location on an automobile and encloses a mobility vehicle during storage or transportation, wherein said MVE is comprised of a structure including an upper surface, a lower surface, a front side wall, a rear side wall, a right side wall and a left side wall, wherein said front side wall is secured to said structure by an upper securing device and at least one hinge that is attached at a lower edge of said front side wall and a front edge of said lower surface, wherein the at least one hinge allows said front side wall to be lowered downward to ground level, thereby creating a ramp on which a mobility vehicle enters or exits said structure.

2. The mobility vehicle enclosure as specified in claim 1 wherein the mobility vehicle is selected from the group consisting of a two-wheel scooter, a three-wheel scooter, a four-wheel scooter, a six-wheel scooter, a jet ski, a go-cart, a small motorcycle or a mini motorcycle.

3. The mobility vehicle enclosure as specified in claim 1 wherein the automobile is selected from the group consisting of a car, a truck, a van, or an all-terrain vehicle (ATV).

4. The mobility vehicle enclosure as specified in claim 1 wherein said structure is rectangular.

5. The mobility vehicle enclosure as specified in claim 1 wherein said structure is made of material selected from the group consisting of plastic, metal, wood, or a composite.

6. The mobility vehicle enclosure as specified in claim 1 wherein located at an upper edge of said front side wall is a securing device that allows said front side wall to be maintained in an upward closed position.

7. The mobility vehicle enclosure as specified in claim 1 wherein attached to a lower edge of said left side wall is a rear light assembly that interfaces with the automobile's existing rear lights, wherein when said MVE is secured to a rear location on an automobile, the automobile's rear lights are blocked, wherein said MVE rear light assembly provides a standard light, a brake light, and a reverse light that are viewed from behind said MVE when said MVE is secured to an automobile.

8. The mobility vehicle enclosure as specified in claim 1 wherein located within said structure, on said lower surface is a grated panel that provides a secure surface on which a mobility vehicle is placed upon when the mobility vehicle is within said structure.

9. A mobile vehicle enclosure (MVE) that is secured to a rear location on an automobile and encloses a mobility vehicle during storage or transportation, wherein said MVE is comprised of a structure including:
a) an upper surface with a front edge, a right edge, a rear edge, and a left edge,
b) a lower surface with a front edge, a right edge, a rear edge, and a left edge,
c) a front side wall with an upper edge, a lower edge, a right edge, and a left edge,
d) a rear side wall with an upper edge, a lower edge, a right edge, and a left edge,
e) a right side wall with an upper edge, a lower edge, a front edge, and a rear edge,
f) a left side wall with an upper edge, a lower edge, a front edge and a rear edge,
g) attachment means for securing together said upper surface, said lower surface, said rear side wall, said right side wall and said left side wall,
h) an upper securing device that is located at, and interfaces with, the upper edge of said front side wall and the front edge of said upper surface, wherein said upper securing device secures said front side wall to said upper surface and allows said front side wall to be maintained in an upward closed position,
i) at least one hinge that is attached at the lower edge of said front side wall and the front edge of said lower surface, wherein when said upper securing device is released, the hinge allows said front side wall to be lowered angularly downward with the upper edge of said front side wall resting at ground level, thereby creating a ramp on which a mobility vehicle enters or exits said structure,
j) a rear light assembly that is attached to the substantial midpoint on the lower edge of said left side wall, wherein said rear light assembly interfaces with the automobile's existing rear light circuitry, wherein when said MVE is secured to a rear location on an automobile, the automobile's rear lights are blocked, wherein said MVE rear light assembly provides a standard light, a brake light, and a reverse light that are actuated by the automobile's light circuitry and are viewable from behind said MVE when said MVE is secured to an automobile,
k) a MVE to automobile securing apparatus that comprises a male member extending outward from the lower edge of said right side wall, wherein the male member is inserted within a female member located at a lower rear area of the automobile, wherein once the male member is within the female member, a locking pin is inserted through openings on both members, thereby maintaining said MVE in an upright level position at the rear of the automobile and securing said MVE to the automobile, and
l) a grated panel that is located within said structure on said lower surface, wherein the grated panel provides a secure surface on which a mobility vehicle is placed upon when the mobility vehicle is within said structure, wherein said grated panel facilitates the use of straps that are inserted through the grates and secured to the mobility vehicle.

10. The mobility vehicle enclosure as specified in claim 9 wherein the mobility vehicle is selected from the group consisting of a two-wheel scooter, a three-wheel scooter, a four-wheel scooter, a six-wheel scooter, a jet ski, a go-cart, a small motorcycle or a mini motorcycle.

11. The mobility vehicle enclosure as specified in claim 9 wherein the automobile is selected from the group consisting of a car, a truck, a van, or an all-terrain vehicle (ATV).

12. The mobility vehicle enclosure as specified in claim 9 wherein said structure is rectangular.

13. The mobility vehicle enclosure as specified in claim 9 wherein said structure is made of material selected from the group consisting of plastic, metal, wood, or a composite.

14. The mobility vehicle enclosure as specified in claim 9 wherein the attachment means for securing together said upper surface, said lower surface, said rear side wall, said right side wall and said left side wall are selected from the group consisting of screws, bolts and nuts, an adhesive, welding, or clamps.

15. The mobility vehicle enclosure as specified in claim 9 further comprising a support assembly with a base and a perimeter rail that extends around and upward from side edges of the base, wherein said support assembly having a rear light assembly that interfaces with an automobile's existing light circuitry and is attached to a substantial said support assembly, and a MVE to automobile securing apparatus that includes a male member extending outward from a substantial midpoint at a front-facing location on said support assembly, wherein said support assembly is dimensioned to allow said MVE structure to be placed on the base within the confines of the perimeter rail, wherein said support assembly, with said structure thereon is secured to a rear location on an automobile.

16. The mobility vehicle enclosure as specified in claim 9 further comprising corner guards, wherein a single corner guard is placed at each corner wherein said upper and lower surfaces interface with said side walls, wherein the corner guards strengthen the structural integrity of said structure and protect the corners from damage.

17. A mobility vehicle enclosure that is secured to a rear location on an automobile and enclose a mobility vehicle during storage or transportation, wherein said MVE is comprised of a structure with a front side wall, with an upper edge, a lower edge, a right edge and left edge, a rear side wall with an upper edge, a lower edge, a right edge, and a left edge, and at least four perimeter side walls, with each perimeter side wall having an upper edge, a lower edge, a front edge, and a rear edge, wherein said perimeter side walls are secured together by at least one hinge located at each interfacing upper and lower edge, and said front and rear side walls are secured by at least one hinge at the front or rear edge of the perimeter side wall in an upper or lower location, wherein said hinge securement allows said structure to be maintained in a horizontal orientation, with said perimeter side walls folded and stacked upon each other, and said front and rear side walls to be folded at front and rear locations on the stacked perimeter side walls, wherein to assemble said structure, said perimeter side walls are sequentially unfolded and positioned into a geometric shape, wherein a final perimeter side wall is releasably secured to an initial perimeter side wall by non-permanent attachment means comprising screws, snap-in, detents, bolts and nuts, or clamps, wherein once assembled, said structure is secured to a rear location on an automobile by a MVE to automobile securement apparatus, wherein a rear light assembly is placed at a rear location on said structure, wherein the rear light assembly interfaces via a cable with an automobile's existing rear light circuit to provide a standard light, a brake light, and a reverse light that are actuated by the automobile's light circuitry and are viewable from behind said MVE when said MVE is secured to the automobile, wherein when said structure is assembled, said front side wall is maintained in an upward closed position by a securing device located at an upper edge of said front wall and front edge of an upper positioned perimeter side wall, wherein when the securing device is released, said front side wall pivots on the at least one hinge located at the lower edge to a downward angled position reaching ground level, wherein in the downward position said front side wall functions as a ramp that allows a mobility vehicle to enter or exit said MVE.

18. The mobility vehicle enclosure as specified in claim 17 wherein the mobility vehicle is selected from the group consisting of a two-wheel scooter, a three-wheel scooter, a four-wheel scooter, a six-wheel scooter, a jet ski, a go-cart, a small motorcycle or a mini motorcycle.

19. The mobility vehicle enclosure as specified in claim 17 wherein the automobile is selected from the group consisting of a car, a truck, a van, or an all-terrain vehicle (ATV).

20. The mobility vehicle enclosure as specified in claim 17 wherein said structure is made of material selected from the group consisting of plastic, metal, wood, or a composite.

21. The mobility vehicle enclosure as specified in claim 17 wherein located within said structure on a bottom position side wall is a grated panel that provides a secure surface on which a mobility vehicle is placed upon when the mobility vehicle is within said structure.

22. The mobility vehicle enclosure as specified in claim 17 wherein said MVE to automobile securing apparatus is comprised of a male member extending outward from the lower edge of said right side wall, wherein the male member is inserted within a female member located at a lower rear area of the automobile, wherein once the male member is within the female member, a locking pin is inserted through openings on both members, thereby maintaining said MVE in an upright level position at the rear of the automobile and securing said MVE to the automobile.

23. The mobility vehicle enclosure as specified in claim 17 wherein said securing device for maintaining said front side wall in an upward closed position is selected from the group consisting of a clip, clamp, a latch, an opening and pin, or slot and tab.

24. The mobility vehicle enclosure as specified in claim 17 further comprising a support assembly with a base and a perimeter rail that extends around and upward from side edges of the base, wherein said support assembly having a rear light assembly that interfaces with an automobile's existing light circuitry and is attached to a substantial said support assembly, and a MVE to automobile securing apparatus that includes a male member extending outward from a substantial midpoint at a front-facing location on said support assembly, wherein said support assembly is dimensioned to allow said MVE structure to be placed on the base within the confines of the perimeter rail, wherein said support assembly, with said structure thereon is secured to a rear location on an automobile.

25. The mobility vehicle enclosure as specified in claim 17 further comprising four wheels, with one wheel attached by attachment means at each lower surface corner of said structure, wherein the wheels allow the position or location of said MVE to be selectably determined and altered.

26. The mobility vehicle enclosure as specified in claim 17 wherein the attachment means for attaching the wheels to the lower surface of said MVE are selected from the group consisting of at least one screw, at least one bolt and nut, an adhesive, welding, or press-fitting.

27. The mobility vehicle enclosure as specified in claim 17 further comprising an alarm system that includes a base unit, at least one sensing device and a loudspeaker, wherein the alarm base unit comprises an electronic control circuit that facilitates the operation of the alarm, wherein the base unit is placed inside or outside of said structure, wherein the alarm system is armed, thereby triggering an audible indication when the front side wall is opened and lowered to the ramp position, when a person or object contacts a surface or side wall of said structure, or when a person or object comes within a present proximity to said structure, wherein the alarm system having a fob that is carried or worn, and alerts a person when the alarm is activated, wherein the fob allows for remote operation including arming or disarming the alarm by a person who located at a distance from said MVE.

28. The mobility vehicle enclosure as specified in claim 17 further comprising a rear-view camera, wherein the rear-view camera is secured at a location on the left side wall, thereby directing the view of the camera to an area behind said MVE and the automobile, wherein the rear-view camera is a self-contained apparatus that functions in combination with a screen that is mounted within the automobile in a viewable position by a driver of the automobile, wherein the rear-view camera allows the driver of the automobile to view an area that is blocked by said MVE behind the automobile.

29. The mobility vehicle enclosure as specified in claim 17 wherein the rear-view camera interfaces with and is a component of said rear light assembly.

30. The mobility vehicle enclosure as specified in claim 17 wherein the rear-view camera screen is on a smartphone that functions in combination with a computer application (APP) to control the operation on the rear-view camera.
